(19) United States
(12) Patent Application Publication
(10) Pub. No.: US 2003/0051025 A1
(43) Pub. Date: Mar. 13, 2003

(54) System for multimedia public telecommunication terminal networking

(76) Inventor: Hwang-Sub Kwon, Seoul (KR)

Correspondence Address: DANN DORFMAN HERRELL & SKILLMAN, SUITE 720, 1601 MARKET STREET, PHILADELPHIA, PA, 19103-2307, US

(21) Appl. No.: 10/236,838

(22) Filed: Sep. 6, 2002

(30) Foreign Application Priority Data
Sep. 10, 2001 (KR) 55473/2001

(51) Int. Cl. G06F 15/173; G06F 15/16; H04Q 7/20

(52) U.S. Cl. 709/223; 709/230

(57) ABSTRACT

A system for multimedia public telecommunication terminal networking is disclosed. The system includes: a plurality of multimedia public telecommunication terminals installed at unspecified locations, each terminal being connected to a telephone network and providing telephone service, each terminal being connected to an Internet network and providing Internet service; and a central management server capable of performing telecommunication with the terminals through a connection network and the Internet network, wherein the terminal includes an agent program for generating account data of the telephone service and the Internet service and transmitting the generated account data to the central management server, wherein the central management server includes: an IP address database for managing IP addresses of the terminals and installation location information of the terminals; an account data collecting server for requesting transmission of the account data from the terminal registered in the IP address database according to a fixed schedule; and a database server for storing transmission result information of the account data transmitted from the terminal, wherein the central management server requests transmission of the account data to the terminal registered in the IP address database according to the fixed schedule, and wherein the terminal generates and stores the account data of the services provided to a consumer, and transmits the stored account data to the central management server when receiving a transmission request from the central management server.

### BACKGROUND OF THE INVENTION

1. Field of the Invention

The present invention relates to a system for multimedia public telecommunication terminal networking, and more particularly, to a system for multimedia public telecommunication terminal networking, capable of controlling multimedia public telecommunication terminals remotely, which can provide a telephone function and an Internet function and an ad information display function, through a central management server remote from the multimedia public telecommunication terminal.

Furthermore, the present invention relates to a system for multimedia public telecommunication terminal networking, capable of allowing an administrator to monitor errors of the multimedia public telecommunication terminals remotely, which are installed in an unspecified number of areas, and search the installed position of the broken-down terminal, thereby promptly dealing with the error.

2. Background of the Related Art

Rapid change and development of information telecommunication provide an innovative communication network capable of a very high speed Internet. To adapt to such information-oriented communication society, communication apparatuses and devices having various functions have been developed and provided.

Furthermore, a multimedia public telecommunication terminal having various functions (telephone, Internet, advertisement functions) is also consistent with the information-oriented society. The multimedia public telecommunication terminal, which provides not only the public telephone function but also an Internet connection and e-mail transmission functions as in a computer communication, and various contents, can provide consumers with more effective and more rapid information.

The multimedia public telecommunication terminals for carrying out such functions are managed separately, and an administrator must physically visit locations, in each of which the multimedia public telecommunication terminal is installed, to check the functions of the terminals or calculate recorded information.

However, such method of the conventional multimedia public telecommunication terminal has various problems as follows.

That is, the administrator must visit the locations, in each of which the multimedia public telecommunication terminal is installed, to manage the functions of the terminals installed in unspecified areas or calculate account information, and so it is inconvenient in management and administration.

Moreover, the administrator's visit to the unspecified locations to manage the plural multimedia public telecommunication terminals and calculate the account information causes waste of time and manpower, and thereby additional expenses are incurred.

Additionally, because occurrence of error is checked only when the administrator visits the location in which the multimedia public telecommunication terminal is installed, and inspects the terminal, the multimedia public telecommunication terminal error is left as it is until the administrator's inspection time from the error occurrence time, and so maintenance and repair of the terminal is substantially delayed.

### SUMMARY OF THE INVENTION

Accordingly, the present invention is directed to a multimedia public telecommunication terminal networking system that substantially obviates one or more problems due to limitations and disadvantages of the known art.

An object of the present invention is to provide a multimedia public telecommunication terminal networking system, capable of controlling multimedia public telecommunication terminals remotely, which can provide a telephone function, an Internet function and an advertising information display function, through a central management server remote from the multimedia public telecommunication terminal.

Another object of the present invention is to provide a multimedia public telecommunication terminal networking system, capable of allowing an administrator to remotely monitor errors of the multimedia public telecommunication terminals, which are installed in unspecified number of locations, and search the installed position of the broken-down terminal, thereby promptly dealing with the error.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a system for multimedia public telecommunication terminal networking includes: a plurality of multimedia public telecommunication terminals installed in unspecified locations, each terminal being connected to a telephone network and providing telephone service, the terminal being connected to an Internet network and providing Internet service; and a central management server capable of performing telecommunication with the terminals through a connection network and the Internet network, wherein the terminal includes an agent program for generating account data of the telephone service and the Internet service and transmitting the generated account data to the central management server, wherein the central management server includes: an IP address database for managing IP addresses of the terminals and installation location information of the terminals; an account data collecting server for requesting transmission of the account data to the terminal registered in the IP address database according to a fixed schedule; and a database server for storing transmission result information of the account data transmitted from the terminal, wherein the central management server requests transmission of the account data to the terminal registered in the IP address database according to the fixed schedule, and wherein the terminal generates and stores the account data of the services provided to a consumer, and transmits the stored account data to the central management server if receiving transmission request of the central management server.

Here, it is preferable that the terminal includes a fixed IP address user terminal and a movable IP address user terminal, and the central management server registers fixed IP address of the fixed IP address user terminal in the IP address database, and registers IP address transmitted from the agent program in the IP address database if the movable IP address user terminal is turned on.

Furthermore, the central management server further includes an advertisement server for managing advertisement information. The terminal downloads advertisement information stored in the advertisement server through the Internet network, manages display information of advertisement information cumulatively, and transmits the display information of advertisement information to the central management server if receiving transmission request of the ad information history data from the central management server.

Moreover, the multimedia public telecommunication terminal networking system further includes a maintenance center connected to the central management server through the Internet network, wherein the agent program of the terminal checks error occurrence of the terminal, and transmits information of the error occurrence to the central management server if there is error, and wherein the central management server detects installation position information linked to the IP address of the terminal if receiving information of the error occurrence from the terminal, and notifies it to the maintenance center.

Additionally, the central management server detects installation position information linked to the IP address of the terminal if not receiving the account data from the terminal corresponding to the transmission request signal of the account data transmitted to the terminal according to the fixed schedule, and notifies the maintenance center accordingly.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a view showing a general configuration of a system for multimedia public telecommunication terminal networking according to the present invention;

FIG. 2 illustrates a flow chart showing a data processing of the system for multimedia public telecommunication terminal networking according to the present invention;

FIG. 3 illustrates a configuration view showing a telephone call path and a path of account data generated by telephone call;

FIG. 4 illustrates a flow chart showing an account data processing according to a telephone function of a multimedia public telecommunication terminal;

FIG. 5 illustrates a flow chart showing an account data processing according to an Internet function of the multimedia public telecommunication terminal; and

FIG. 6 illustrates a flow chart showing history occurrence process according to an advertisement display function of the multimedia public telecommunication terminal.

FIG. 7 illustrates a flow chart showing an error checking and repairing process through an agent program of the terminal according to a self-diagnosis.

### DETAILED DESCRIPTION OF THE PREFERRED EMBODIMENT

Reference will now be made in detail to the preferred embodiments of the present invention, examples of which are illustrated in the accompanying drawings. Additionally, it will be appreciated by those who have skill in this field that specific components and parts, such as elements of circuits specifically described in the following, are just described for readers understanding, and the present invention can be carried out with equivalents of the specifically described components.

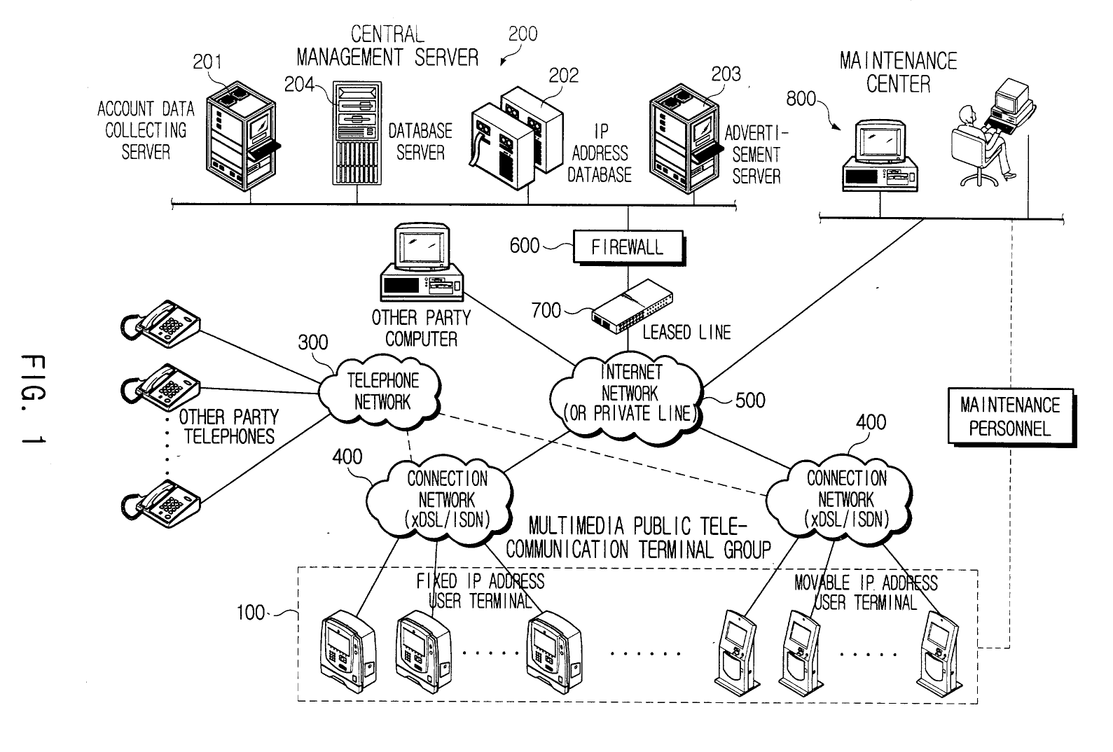

Referring to FIGS. 1 to 3, the configuration of the present invention will be described as follows.

First, as shown in FIG. 1, the system for multimedia public telecommunication terminal networking according to the present invention includes a multimedia public telecommunication terminal group (hereinafter, called terminal group) 100 installed separately in an unspecified number of locations, a central management server 200 for controlling the terminal group 100, a telephone network 300 for allowing a telephone call using each multimedia public telecommunication terminal (hereinafter, called terminal) within the terminal group 100, and a connection network 400 and an Internet network 50 for providing Internet service. A firewall 600 and a leased line 700 are installed between the Internet network 500 and the central management server 200. Furthermore, a maintenance center 800 for maintaining/repairing each terminal within the terminal group 100 is connected to the Internet network 500.

Here, the terminal group 100 includes a fixed IP address user terminal and a movable IP address user terminal. Additionally, each terminal has an agent program therein to directly manage transmission of the account data and notification of error occurrence.

Moreover, the central management server 200 includes an account data collecting server 201 for storing and managing the account data, an IP address database 202 for storing and managing IP address of each terminal, an advertisement server 203 for storing and managing advertisement information, and a database server 204 for managing various databases. Here, in the IP address database 202, IP addresses of the terminals (fixed IP address user terminals and movable IP address user terminals) included in the terminal group 100 are registered. At this time, for the fixed IP address user terminal, fixed IP address given initially is registered in the IP address database 202, and for the movable IP address user terminal, movable IP address information transmitted from the terminal at the time that the terminal is turned on is registered in the IP address database 202.

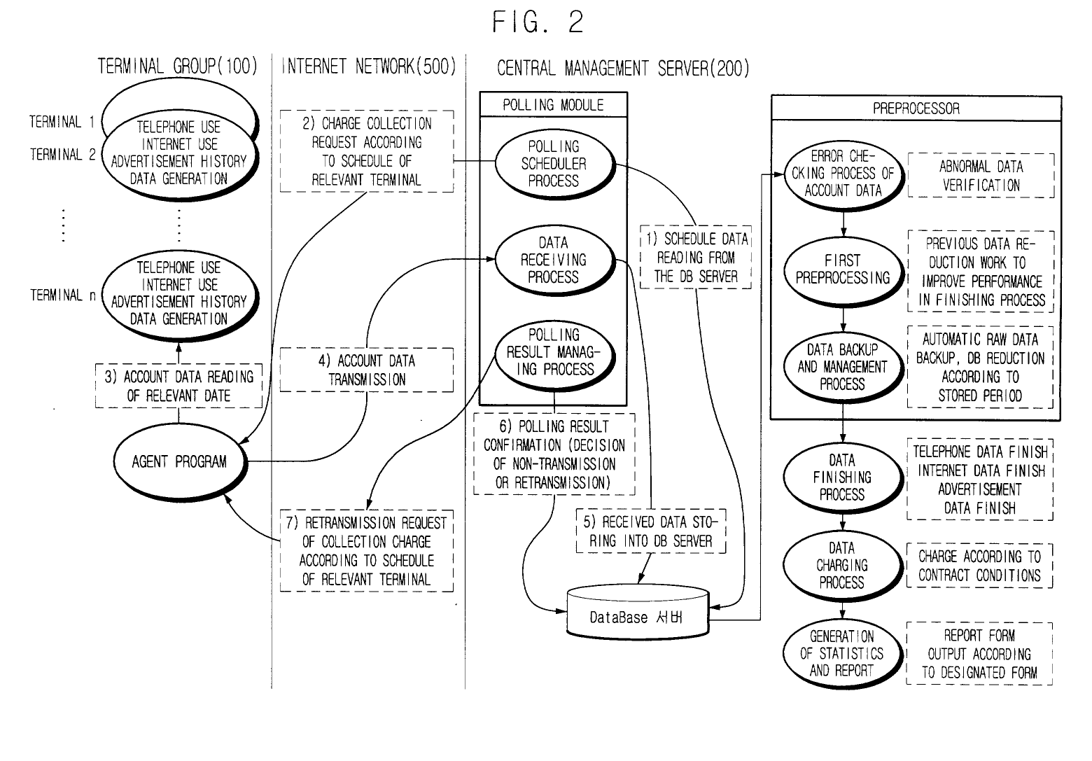

Referring now to FIG. 2, a data processing of the system for multimedia public telecommunication terminal networking will be described. The account data is generated from the terminal when any of the following occur: (1) a consumer uses a telephone call service using the terminal; (2) a consumer uses an Internet service using the terminal; or (3) an advertisement history is made according to an ad display action.

FIG. 2 shows a process that the account data is transmitted from the multimedia public telecommunication terminal networking system when the account data is generated from the terminal. That is, the multimedia public telecommunication terminal networking system according to the present invention is divided into the terminal group 100, the Internet network 500, and the central management server 200 including a preprocessing device. The central management server 200 reads a polling schedule of the terminal from the database server 204 using a polling module, and then requests transmission of the account data according to the schedule of each data within the terminal group 100 (polling scheduler process). Here, the central management server 200 can request the account data transmission from each terminal using the IP address registered in the IP address database 202.

Meanwhile, the agent program within the terminal receiving the transmission request of the account data according to a schedule detects the account data by date stored in the terminal, and transmits the account data to the central management server 200. The central management server 200 stores the account data received from the agent program of the terminal in the database server 204 (data receiving process). At this time, the central management server 200 stores the account data received from each terminal in the database server 204 after linking the account data to the IP address of the relevant terminal, thereby managing the account data of each terminal separately.

The central management server 200 analyzes the account data for each terminal stored in the database server 204 and checks a polling result. According to circumstances, the central management server 200 determines whether or not retransmission is needed if the account data is not transmitted or there is any error in the account data. Here, if the retransmission is needed, the central management server 200 requests retransmission of the account data according to a schedule of the relevant terminal (polling result managing process).

Meanwhile, the preprocessing device within the central management server 200 verifies whether or not the account data stored in the database server 204 is normal (account data error checking process), and carries out data reduction work to improve performance in a finishing process (first preprocessing). Furthermore, the preprocessing device carries out functions in relation to data backup and management, i.e., backup of first processed account data and reduction of the account data stored in the database server 204 according to stored period (data backup and management process).

Additionally, the preprocessing device finishes telephone data and contents data including advertisement on the basis of a regular period unit (data finishing process). The preprocessing device carries out a fee charging operation according to contract condition after the data finishing (data charging process). After that, the preprocessing device outputs the accounting result in a designated report form (statistics and report generating process).

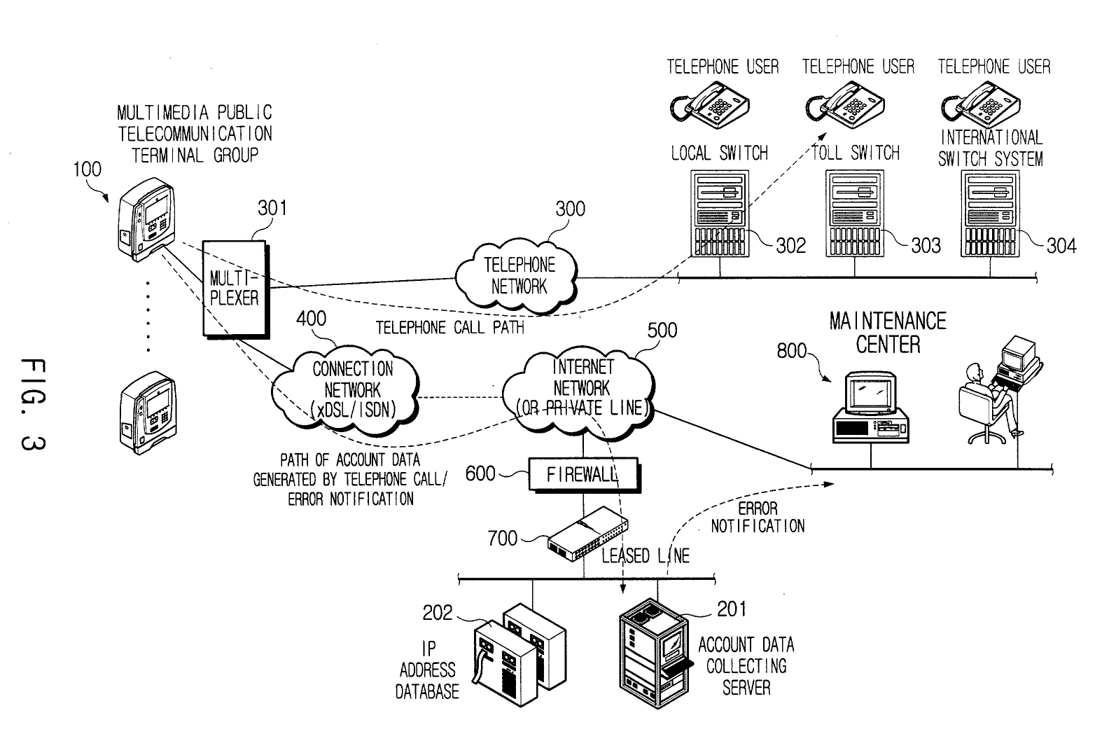

Referring to FIG. 3, the telephone call path and the path of the account data generated by the telephone call will be described. If the consumer calls another party's telephone number through his own terminal, the terminal is connected to the other party's telephone through a multiplexer 301, the telephone network 300, and a switch relevant to the other party's telephone number (a local switch 302, a toll switch 303, an international switch 304, and so on). At this time, the account data is transmitted to the account data collecting server 201 of the central management server 200 through the terminal, the multiplexer 301, the connection network 400 and the Internet network 500. Here, the multiplexer 301 serves to separate sound signals and data and transmit them to the telephone network 300 and the connection network 400, respectively.

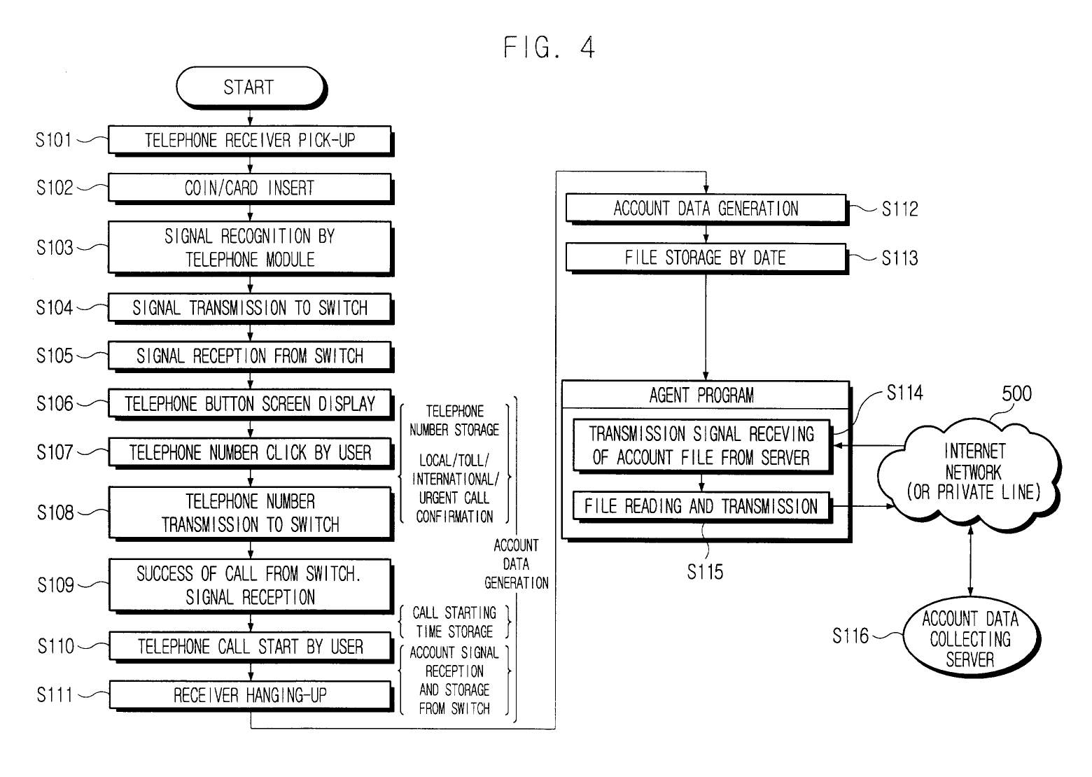

Referring to FIGS. 4 to 7, the operation of the present invention will be described as follows.

As shown in FIG. 4, when the consumer uses the telephone service through the terminal, the consumer picks up a telephone receiver (S101), and inserts coins or a card (S102). Then, the telephone module recognizes insert signal of the coins or the card (S103) and transmits signal to the switch (S104). When an answer signal is received from the switch (S105), the terminal displays a telephone button screen on a main screen (S106). When the consumer inputs telephone number on the telephone button screen (S107), the terminal transmits the input telephone number to the switch through the multiplexer 301 (S108). At this time, the terminal divides and stores the telephone number, input by the consumer, into local, toll, international and urgent calls.

After that, when call success signal is received from the switch (S109), the terminal is converted into a call available condition, and the consumer can speak with the other party using the terminal (S100). At this time, the terminal stores call start time information and receives and stores accounting signal from the switch. After that, when the consumer ends the call (S111), the terminal generates account data by the telephone call (S112) and stores the generated account data by date (S113).

Moreover, the central management server 200 requests the account data to be transmitted to the terminal according to the schedule (S114). The agent program of the terminal receiving the transmission request of the account data from the central management server 200 reads the account data stored in the terminal and transmits it to the central management server 200 through the connection network 400 and the Internet network 500. The central management server 200 stores the account data in the account data collecting server 201 through the multiplexer 301, the connection network 400 and the Internet network 500.

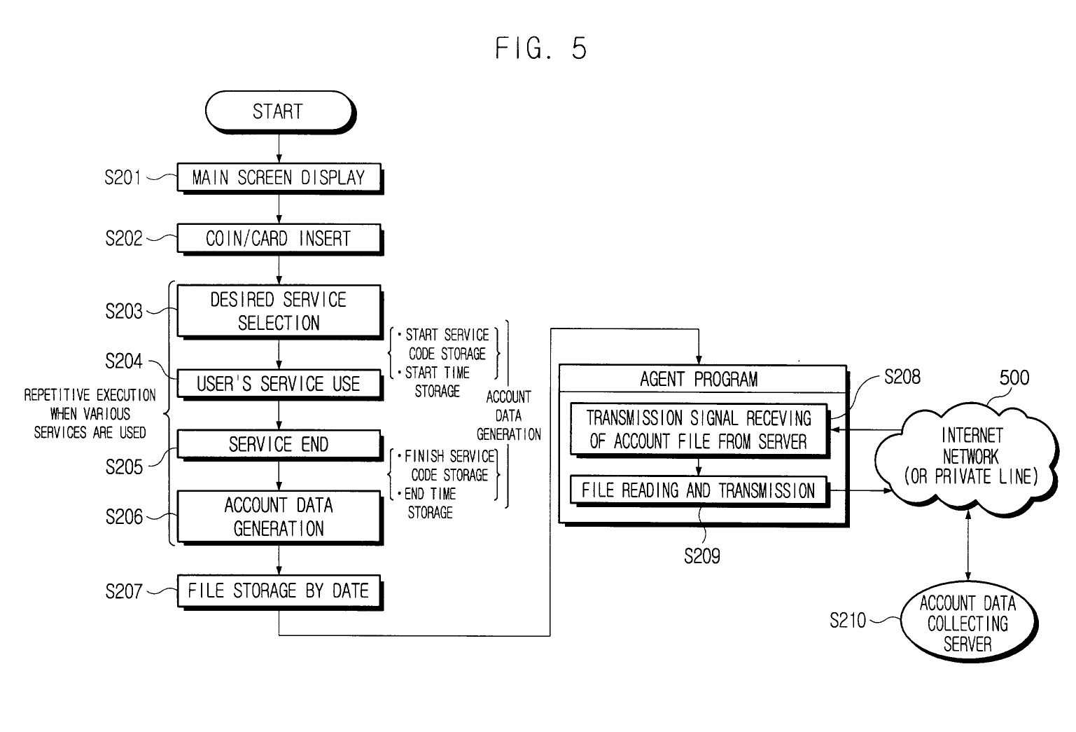

As shown in FIG. 5, if the consumer uses Internet service through the terminal, various service items capable of being provided form the terminal are displayed on the main screen (S201). When the consumer inserts the coins or card (S202) and selects a desired service (here, Internet service), the terminal stores code of the consumer's selected service, and stores a start time of the service (S203). The terminal connects to the Internet network 500 through the connection network 400 and provides the consumer with the selected service (S204).

After that, when the consumer finishes the user of the service, the terminal stores code of the finished service and stores an end time of the service (S205).

Furthermore, the terminal generates account data using a kind, the start time and the end time of the service, and stores the generated account data by date (S207).

Moreover, the central management server 200 requests transmission of the account data to the terminal according to the schedule (S208). The agent program of the terminal receiving the transmission request of the account data from the central management server 200 reads the account data stored in the terminal and transmits it to the central management server 200 through the multiplexer 301, the connection network 400 and the Internet network 500. The central management server 200 stores the account data received through the multiplexer 301, the connection network 400 and the Internet network 500 in the account data collecting server 201.

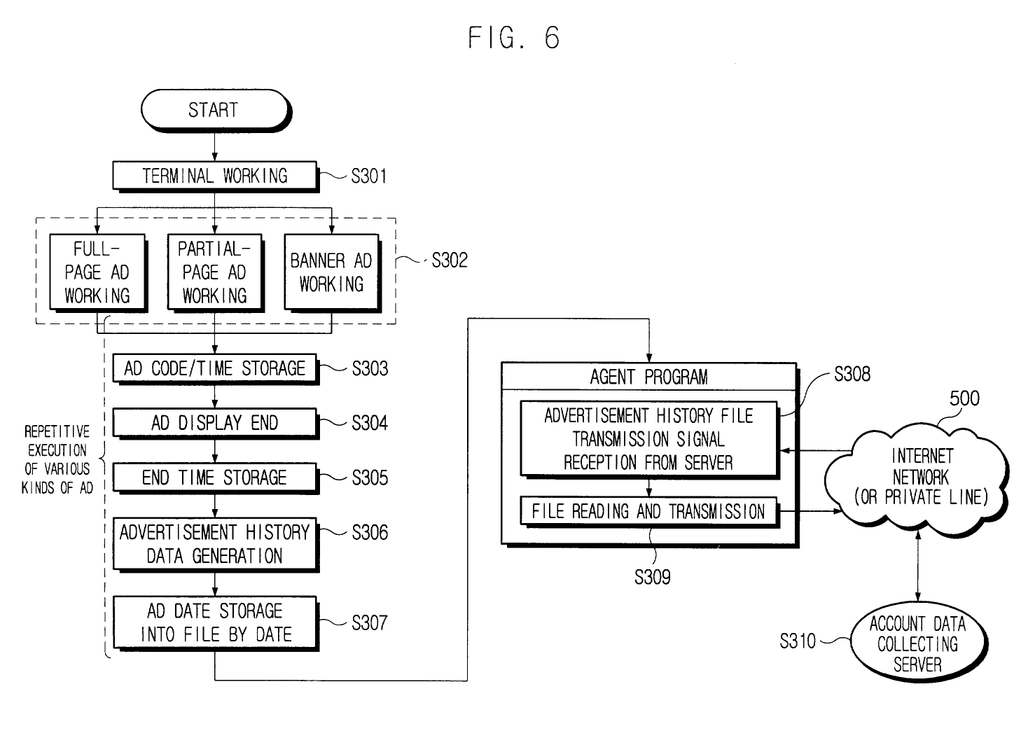

Referring now to FIG. 6, if an advertisement provided by an advertiser is displayed on the terminal in a prescribed period of time unit, the terminal connects to the advertisement server 203, located in the central management server 200, through the multiplexer 301, the connection network 400 and the Internet network 500, and then downloads and stores ad information stored in the advertisement server 203 at any time.

After that, when the terminal is operated (S301), full-page advertisement, partial-page advertisement or banner advertisement stored in the terminal is displayed on the screen according to a display schedule of the advertisement information (S302).

The terminal stores code and start time of advertisement displayed now according to the schedule (S303), and stores end time of the advertisement (S305) when the advertisement is all displayed (S304).

The terminal generates ad information history data (S306) and stores the generated history data by date (S307).

The central management server 200 requests transmission of the ad information history data to the terminal (S308). The agent program of the terminal receiving the transmission request of the ad information history data from the central management server 200 reads the ad information history data stored in the terminal and transmits it to the central management server 200 through the multiplexer 301, the connection network 400 and the Internet network 500. The central management server 200 stores the ad information history data in the account data collecting server 201 through the multiplexer 301, the connection network 400 and the Internet network 500.

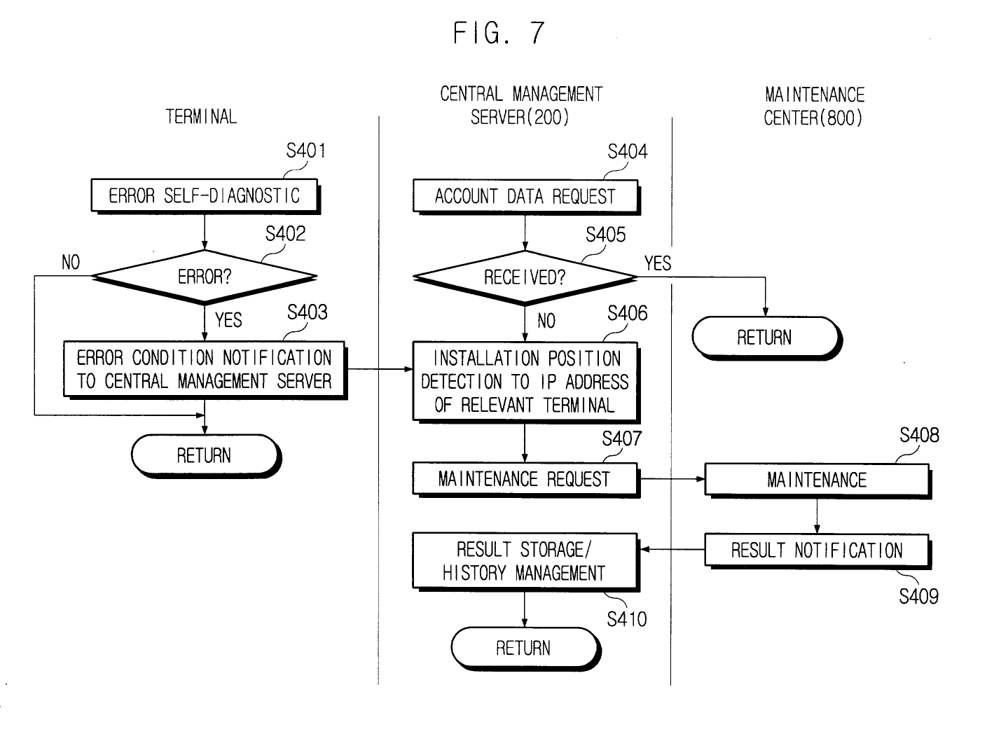

As shown in FIG. 7, the terminal diagnoses its own functions (for example, a telephone network condition, a sender/receiver condition, operation of a coil selector, operation of a card reader, and so on) through the agent program (S401) and checks occurrence of error (S402).

If the terminal is out of order (for example, signal is not received from the switch, the telephone module is out of order, or advertisement information is displayed abnormally), the agent program notifies error occurrence information to the central management server 200 through the multiplexer 301, the connection network 400 and the Internet network 500 (S403).

Meanwhile, if the central management server 200 receives error occurrence information from the terminal or cannot receive the account data from the terminal after requesting the account data (for example, an abnormal condition of the Internet network) (S405), the central management server 200 detects an installation location of the relevant terminal using the IP address of the relevant terminal registered in the IP address database 202 (S406), and requests repair of the relevant terminal by the maintenance center 800 connected to the Internet network 500 (S407).

The maintenance center 800 carries out the maintenance and repair of the relevant terminal received from the central management server 200 (S408), and notifies the result of the maintenance repair to the central management server 200 (S409). Then, the central management server 200 stores the maintenance result of the relevant terminal and manages history of the relevant terminal (S410).

Therefore, the multimedia public telecommunication terminal according to the present invention can provide the consumer with not only the telephone function but also the Internet function, generate the account data, store and display advertisement information, generated the ad information history data, and collect and manage the generated account data and ad information history data by the central management server 200, thereby providing convenience in management. Furthermore, if the multimedia public telecommunication terminal is out of order, a cause of error is automatically notified to the central management server 200, and the central management server 200 detects the installation position of the relevant terminal and notifies it to the maintenance center 800, thereby coping with the error rapidly.

Finally, the multimedia public telecommunication terminal networking system according to the present invention has several advantages as follows.

That is, the system controls remotely the account data of the terminals installed in unspecified areas, thereby providing convenience because it is not needed that the administrator visits the installation position of the terminals.

Furthermore, because the system carries out self-diagnosis to error occurrence through the agent program installed in the terminal and notifies the error occurrence to the central management server and the central management server detects the position of the relevant terminal using IP address of relevant the terminal and notifies detected position information and information of error cause to the maintenance center, thereby coping with the error rapidly.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

1. A system for multimedia public telecommunication terminal networking, the system comprising:
a plurality of multimedia public telecommunication terminals installed at unspecified locations, each terminal being connected to a telephone network and providing telephone service, each terminal being connected to an Internet network and providing Internet service; and a central management server capable of performing telecommunication with the terminals through a connection network and the Internet network;
wherein the terminal includes an agent program for generating account data of the telephone service and the Internet service and transmitting the generated account data to the central management server,
wherein the central management server includes: an IP address database for managing IP addresses of the terminals and installation location information of the terminals;
an account data collecting server for requesting transmission of the account data from the terminal registered in the IP address database according to a fixed schedule; and
a database server for storing transmission result information of the account data transmitted from the terminal,
wherein the central management server requests transmission of the account data to the terminal registered in the IP address database according to the fixed schedule, and
wherein the terminal generates and stores the account data of the services provided to a consumer, and transmits the stored account data to the central management server when receiving a transmission request from the central management server.

2. The system according to claim 1, wherein the terminal includes a fixed IP address user terminal and a movable IP address user terminal,
wherein the central management server registers fixed IP address of the fixed IP address user terminal in the IP address database, and registers IP address transmitted from the agent program in the IP address database if the movable IP address user terminal is turned on.

3. The system according to claim 1, wherein the central management server further includes an advertisement server for managing advertisement information, and
wherein the terminal downloads advertisement information stored in the advertisement server through the Internet network, manages display information of advertisement information cumulatively, and transmits the display information of advertisement information to the central management server when receiving a transmission request of the ad information history data from the central management server.

4. The system according to claim 1, further comprising a maintenance center connected to the central management server through the Internet network,
wherein the agent program of the terminal checks an error occurrence of the terminal, and transmits information of the error occurrence to the central management server if there is error, and
wherein the central management server detects installation position information linked to IP address of the terminal when receiving information of the error occurrence from the terminal, and notifies a maintenance center of the error.

5. The system according to claim 4, wherein the central management server detects installation location information linked to the IP address of the terminal if not receiving the account data from the terminal corresponding to the transmission request signal of the account data transmitted to the terminal according to the fixed schedule, and notifies the maintenance center of the non-receipt of the account data.
